(19) United States
(12) Patent Application Publication
(10) Pub. No.: US 2020/0162698 A1
(43) Pub. Date: May 21, 2020

(54) SMART CONTACT LENS BASED COLLABORATIVE VIDEO CONFERENCING

(71) Applicant: INTERNATIONAL BUSINESS MACHINES CORPORATION, ARMONK, NY (US)

(72) Inventors: Sarbajit K. Rakshit, Kolkata (IN); John M. Ganci, JR., Raleigh, NC (US); James E. Bostick, Cedar Park, TX (US); Martin G. Keen, Cary, NC (US)

(21) Appl. No.: 16/196,424

(22) Filed: Nov. 20, 2018

(51) Int. Cl. H04N 7/15; H04L 29/06; G06F 17/28; G02C 7/04

(52) U.S. Cl. CPC H04N 7/15; G02C 7/04; G06F 17/28; H04L 65/4076

(57) ABSTRACT

A method and system for collaborative conferencing between participants wearing smart contact lenses is provided. A first video content of a presentation is received by a master device from a first device paired with a first set of smart contact lenses. A second video content of the presentation is received by the master device from a second device paired with a second set of smart contact lenses. After analyzing the first and the second video content to identify a first and a second set of parameters, if the first and the second set of parameters fail to exceed a threshold, a third video content is created from combining the first and the second video content and the third video content is transmitted to the first and the second set of smart contact lenses for display.

### FIELD

The present invention relates generally to a computer program product, a computer system, and a method for collaborative conferencing between participants wearing smart contact lenses.

### BACKGROUND

Video conferencing is an effective communication method for business and personal uses. At the most basic level, a video conference is a live and real-time visual connection over a network between two or more people. Current video conferencing implementations involve capturing audio and video information and transmitting the captured signals to one or more participants in the video conference. According to some examples, images and audio from numerous video cameras may be merged by a conference bridge and transmitted to the conference participants for viewing.

### SUMMARY

The invention provides a method, and associated computer system and computer program product, executed on a computing device for collaborative conferencing between participants wearing smart contact lenses. The method includes: receiving, by one or more processors from a first device paired with a first set of smart contact lenses worn by a first participant of the participants, a first video content of a presentation; and receiving, by the one or more processors from a second device paired with a second set of smart contact lenses worn by a second participant of the participants, a second video content of the presentation. The method then includes: analyzing, by the one or more processors, the first video content to identify a first set of parameters; and analyzing, by the one or more processors, the second video content to identify a second set of parameters. Then, if the first and the second set of parameters fail to exceed a threshold, the method further includes:

combining, by the one or more processors, the first video content and the second video content to create a third video content; and transmitting, by the one or more processors, the third video content to the first and the second set of contact lenses for display.

The present invention provides a method and associated system capable of generating content associated with an advantageous presentation viewing angle and transmitting that content to participants of the presentation.

### BRIEF DESCRIPTION OF THE DRAWINGS

FIG. 1 illustrates a block diagram of a system for collaborative conferencing between participants wearing smart contact lenses, in accordance with embodiments of the present invention.

FIG. 2 illustrates a detailed block diagram of the system of FIG. 1 for collaborative conferencing between participants wearing smart contact lenses, in accordance with embodiments of the present invention.

FIG. 3 is a flowchart of a process for collaborative conferencing between participants wearing smart contact lenses, in accordance with embodiments of the present invention.

FIG. 4 is a block diagram of a computing device included within the system of FIG. 1 and that implements the process of FIG. 3, in accordance with embodiments of the present invention.

### DETAILED DESCRIPTION

As video conferencing has become commonplace, several problems exist with current implementations. For example, participants in video conferences may need to hold the camera-based devices during the presentation so as to capture video and/or audio information, which may become tedious. In other solutions, participants may need to focus the camera-based device on a fixed seating position of the speaker or presenter. It is often difficult to choose what portions of the presentation to display and which angles of the presentation may be free from obstacles. Thus, there exists a need in the art to overcome at least some of the deficiencies and limitations described.

The current invention provides a solution to these problems. According to at least one embodiment disclosed herein, a system is configured for executing a method for collaborative conferencing between co-located participants wearing smart contact lenses. The method includes receiving first video content of a presentation from a first device, where the first device is paired with a first set of smart contact lenses worn by a first participant. The method also includes receiving second video content of a presentation from a second device, where the second device is paired with a second set of smart contact lenses worn by a second participant. Subsequent analyzing the first and the second video content, the system identifies a first set of parameters associated with the first video content and a second set of parameters associated with the second video content.

The system contemplated herein then cognitively analyzes video content from numerous sets of smart contact lenses worn by users to determine which video content is most preferable to display to the participants in the video conference and from what viewing angle. To accomplish this, the system analyzes the first and the second set of parameters to identify if any of the sets of parameters exceed a threshold. In an illustrative example, the first set of parameters may exceed the threshold when the viewing angle (e.g., the view from the first set of smart contact lenses) captures the entirety of the presentation, accounting for the location of each of the participants. In this example, the system may then transmit the first video content to the first and second set of contact lenses for display. Thus, the system contemplated herein alleviates the need for fixed-positioned video camera seating and the need for participants to hold the camera-based devices during the presentation so as to capture video and/or audio information.

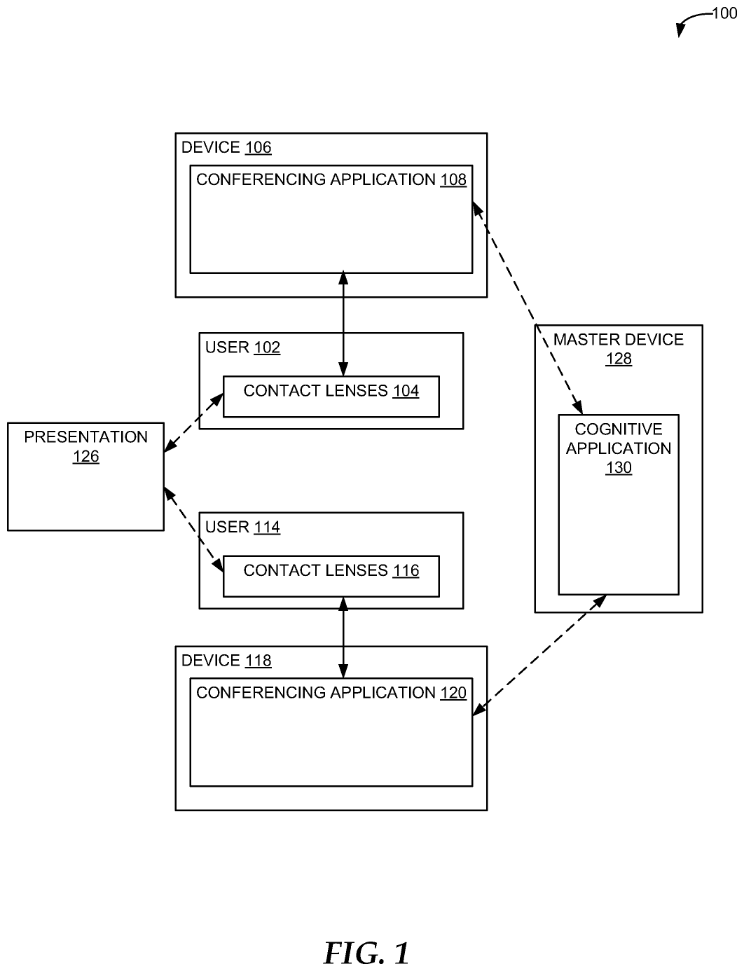

FIG. 1 illustrates a block diagram of a system for collaborative conferencing between participants wearing smart contact lenses, in accordance with embodiments of the present invention.

The system 100 of FIG. 1 includes a first device 106, a second device 118, a master device 128, and a presentation 126. The first device 106 is paired with a first set of smart contact lenses 104 worn by a first user 102. The second device 118 is paired with a second set of smart contact lenses 116 worn by a second user 114. In some examples, the first user 102 and the second user 114 may “join” or enter a video conference by accessing the conferencing application 108 or the conferencing application 120 on the first device 106 or the second device 118, respectively.

The first user 102 and the second user 114 are co-located users viewing the presentation 126. It should be appreciated that some scenarios include a portion of the participants in the presentation 126 wearing the smart contact lenses, while others do not. The first set of smart contact lenses 104 and the second set of smart contact lenses 116 each include: one or more video cameras, one or more antennas, and one or more displays within the lenses of the first set of smart contact lenses 104 and the second set of smart contact lenses 116. The one or more displays within the lenses may display the video content to the user in a peripheral view. The first device 106 and the second device 118 each include one or more microphones.

When the first user 102 views the presentation 126, the one or more video cameras of the first set of smart contact lenses 104 captures a first video content associated with the presentation 126. The one or more antennas of the first set of smart contact lenses 104 transmits the first video content to a conferencing application 108 of the first device 106. Moreover, the one or more microphones of the first device 106 may capture audio associated with the presentation 126 and may store the audio in the conferencing application 108. Similarly, the one or more microphones of the first device 118 may capture audio associated with the presentation 126 and may store the audio in the conferencing application 120.

The conferencing application 108 associated with the first device 106 transmits the first video content and the audio content to the master device 128. The conferencing application 120 associated with the second device 118 transmits the second video content and the audio content to the master device 128. Then, according to some examples, a cognitive application 130 of the master device 128 analyzes, in real-time, the first video content to identify a first set of parameters and analyzes the second video content to identify a second set of parameters. It should be appreciated that, according to further examples, the cognitive application 130 of the master device 128 may analyze video recordings of the first and the second video content to identify the first and the set of parameters, respectively. In this example, the first and the second video content may be subjected to an opt-in/opt-out feature.

The first set of parameters and the second set of parameters include one or more of: a number of the participants, a location of each of the participants, and a viewing angle associated with a view of each of the participants. The cognitive application 130 may utilize one or more algorithms to identify the first and the second set of parameters, where such one or more algorithms may include: a location or GPS-based algorithm (e.g., to identify the location of each of the participants and/or the number of the participants) and/or a field of view or an angle of view algorithm (e.g., to identify the viewing angle associated with the view of each of the participants), among others. In further examples, the cognitive application 130 may further utilize linguistic analysis and/or linguistic algorithms to identify a context of the presentation 126. For example, the cognitive application 130 may utilize natural language processing (NLP) to identify a discussion topic of the presentation 126 and/or a number of participants engaged in the discussion.

According to some examples, the first set of parameters are identical to the second set of parameters. According to further examples, a subset of the first set of parameters are identical to the second set of parameters. According to further examples, the first and the second set of parameters are unique.

If the cognitive application 130 identifies the first set of parameters as exceeding a threshold, the cognitive application 130 transmits the first video content to the one or more displays within the first set of smart contact lenses 104 and the second set of smart contact lenses 116 to display such video content to the first user 102 and the second user 114, respectively. For example, the first set of parameters may exceed the threshold when the viewing angle (e.g., the view from the first set of smart contact lenses 104) captures the entirety of the presentation 126, accounting for the location of each of the participants. In another example, the first set of parameters may exceed the threshold when the cognitive application 130 captures a facial image of the speaker of the presentation 126. In a further example, the threshold may require that the first user 102 view both the presentation 126 and the speaker simultaneously. The cognitive application 130 then transmits the audio associated with the first video content to the first device 106 and the second device 118.

If the second set of parameters exceeds the threshold, the cognitive application 130 transmits the second video content to the one or more displays within the first set of smart contact lenses 104 and the second set of smart contact lenses 116 to display such content to the first user 102 and the second user 114, respectively. The cognitive application 130 also transmits the audio content associated with the second video content to the first device 106 and the second device 118.

However, if the first and the second set of parameters fail to exceed the threshold, the cognitive application 130 may transmit a request to a third user associated with the master device 128. According to an example, the third user may act as the speaker of the presentation and/or a user overseeing the presentation. The request may prompt the third user to identify any gaps in the first or the second video content. Once the third user responds to the request, the cognitive application 130 may modify the first or the second video content and may then transmit the first or the second video content to one or more displays within the first set of smart contact lenses 104 and the second set of smart contact lenses 116 for display.

In other examples, if the first and the second set of parameters fails to exceed the threshold, the cognitive application 130 may combine the first and the second video content to create a third video content. The first and the second set of parameters may fail to exceed the threshold when the cognitive application 130 is only able to capture the facial image of the speaker of the presentation 126 and the threshold requires that the facial image of each of the participants in the presentation 126 are captured. Then, the cognitive application 130 transmits the third video content to the one or more displays within the first set of smart contact lenses 104 and the second set of smart contact lenses 116 to display to the first user 102 and the second user 114, respectively.

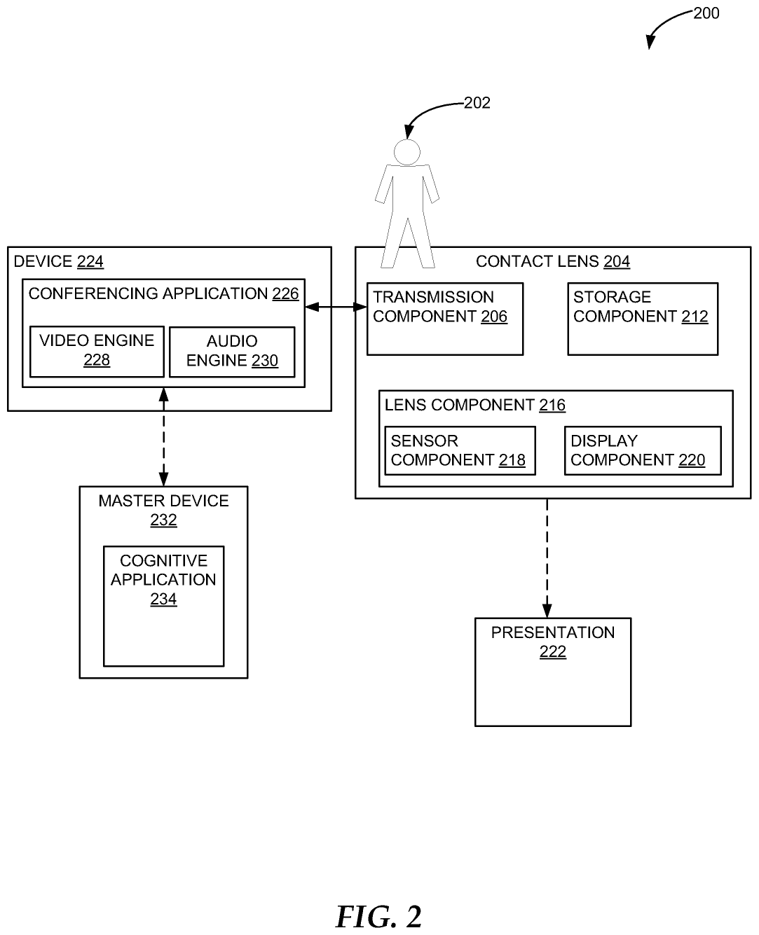

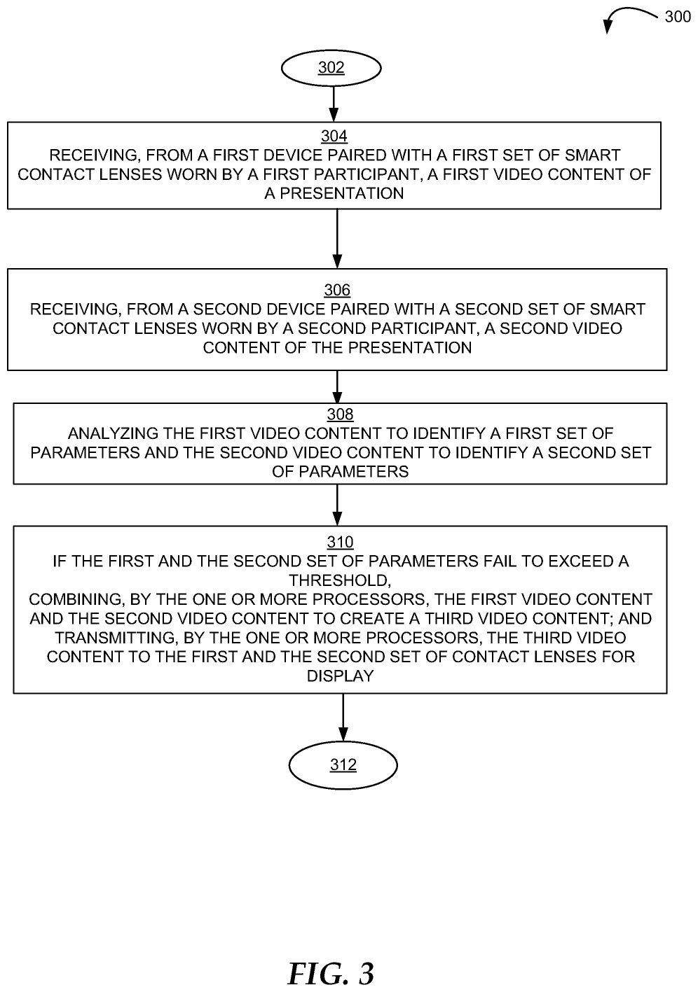

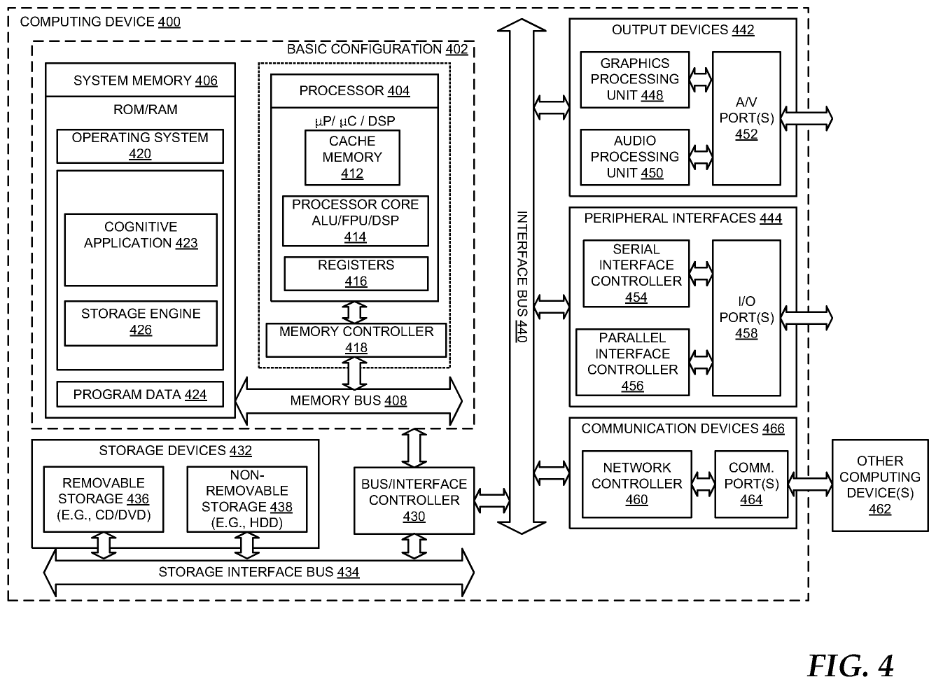

The functionality of the components shown in FIG. 1 is described in more detail in the discussion of FIG. 2, FIG. 3, and FIG. 4 presented below.

FIG. 2 illustrates a detailed block diagram of the system of FIG. 1 for collaborative conferencing between participants wearing smart contact lenses, in accordance with embodiments of the present invention.

The system 200 of FIG. 2 include a master device 232, a device 224, and a presentation 222. As explained with regards to FIG. 1, the device 224 is paired with a set of smart contact lenses 204 worn by a user 202. The user 202 is co-located with one or more additional users viewing the presentation 222. The set of smart contact lenses 204 may include: a transmission component 206, a storage component 212, and a lens component 216.

The transmission component 206 of the set of smart contact lenses 204 may include one or more antennas configured to transmit captured video content of the presentation 222 to a conferencing application 226 of the device 224. According to some examples, the transmission component 206 may communicate with the conferencing application 226 of the device 224 via Bluetooth technology. The conferencing application 226 may include a video engine 228 and an audio engine, among others.

The storage component 212 of the set of smart contact lenses 204 may be configured to store the captured video content. The lens component 216 of the set of smart contact lenses 204 may include: a sensor component 218 and a display component 220. The sensor component 218 may include one or more video cameras and/or sensors for capturing video content of the presentation 222. The display component 220 may be configured to display the video content associated with the presentation 222. It should be appreciated that additional components/engines are contemplated and the components are not limited to those described herein.

An illustrative example of the process is as follows. When the user 202 views the presentation 222, the one or more video cameras and/or the sensors of the sensor component 218 capture video content associated with the presentation 222. The captured video content may be stored in the storage component 212. In some examples, the one or more antennas of the transmission component 206 may transmit the captured video content of the presentation 222 to the conferencing application 226 of the device 224.

The video engine 228 may be configured to receive the captured video content from the set of smart contact lenses 204. The audio engine 230 may include one or more microphones and may be configured to capture and store the audio content associated with the presentation 222. The conferencing application 226 of the device 224 then transmits the video content and the audio content to the master device 232. A cognitive application 234 of the master device 232 then analyzes the video content to identify a set of parameters, as explained in relation to FIG. 1. According to some examples, the cognitive application 234 may utilize one or more algorithms to identify the set of parameters. If the cognitive application 234 determines that the set of parameters exceeds a threshold, the cognitive application 234 transmits the video content to the display component 220 for display to the user 202. The cognitive application 234 then transmits the audio associated with the video content to the device 224.

FIG. 3 is a flowchart of a process for collaborative conferencing between participants wearing smart contact lenses, in accordance with embodiments of the present invention.

The process 300 of FIG. 3 begins with a step 302. The step 302 is followed by a step 304, where the cognitive application of the master device (e.g., the cognitive application 130 of the master device 128 of FIG. 1), receives a first video content of a presentation from a first device paired with a first set of smart contact lenses worn by a first participant. The first participant may be co-located with one or more additional participants. At least one of the one or more additional participants may be wearing smart contact lenses. The step 304 is followed by a step 306, where the cognitive application receives a second video content of a presentation from a second device paired with a second set of smart contact lenses worn by a second participant.

The step 306 is followed by a step 308, where the cognitive application analyzes the first video content to identify a first set of parameters and also analyzes the second video content to identify a second set of parameters. As explained previously, the parameters may be selected from the group consisting of: a number of the participants, a location of each of the participants, and a viewing angle associated with a view of each of the participants.

The step 308 is followed by a step 310, where, when the cognitive application determines that the first and second set of parameters fail to exceed a threshold, the cognitive application combines the first and the second video content to create a third video content. The cognitive application then analyzes the third video content to determine if the third content exceeds the threshold. If the cognitive application identifies the third content as exceeding the threshold, the cognitive application transmits the third video content to the first and second set of contact lenses for display. If the cognitive application determines that the first set of parameters exceeds the threshold, the cognitive application transmits the first video content to the first and second set of contact lenses for display. If the cognitive application determines that the second set of parameters exceeds the threshold, the cognitive application transmits the second video content to the first and second set of contact lenses for display.

A step 312 follows the step 318, which concludes the process.

FIG. 4 is a block diagram of a computing device included within the system of FIG. 1 and that implements the process of FIG. 3, in accordance with embodiments of the present invention.

In some embodiments, the present invention may be a system, a method, and/or a computer program product. For example, a computing device is utilized for collaborative conferencing between participants wearing smart contact lenses. In an example, basic configuration 402, the computing device 400 includes one or more processors 404 and a system memory 406. A memory bus 408 is used for communicating between the processor 404 and the system memory 406. The basic configuration 402 is illustrated in FIG. 4 by those components within the inner dashed line.

Depending on the desired configuration, the processor 404 may be of any type, including but not limited to a microprocessor (μP), a microcontroller (μC), a digital signal processor (DSP), or any combination thereof. The processor 404 may include one more levels of caching, such as a level cache memory 412, an example processor core 414, and registers 416, among other examples. The example processor core 414 may include an arithmetic logic unit (ALU), a floating point unit (FPU), a digital signal processing core (DSP Core), or any combination thereof. An example memory controller 418 is used with the processor 404, or in some implementations the example memory controller 418 is an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 includes an operating system 420, one or more engines, such as a cognitive application 423, and program data 424. In some embodiments, the cognitive application 423 may be a cognitive analysis engine or a cognitive analysis service.

The cognitive application 423 may receive a first video content of a presentation from a first device paired with a first set of smart contact lenses worn by a first participant. The cognitive application 423 may also receive a second video content of a presentation from a second device paired with a second set of smart contact lenses worn by a second participant. The cognitive application 423 may then analyze the first video content to identify a first set of parameters and may also analyze the second video content to identify a second set of parameters. Then, if the cognitive application 423 identifies the first and the second set of parameters as failing to exceed a threshold, the cognitive application 423 may combine the first and the second video content to create a third video content. The cognitive application 423 may then transmit the third video content to the first and the second set of contact lenses for display. However, if the cognitive application 423 determines that the first set of parameters exceeds the threshold, the cognitive application 423 transmits the first video content to the first and second set of contact lenses for display. Alternatively, if the cognitive application 423 determines that the second set of parameters exceeds the threshold, the cognitive application 423 transmits the second video content to the first and second set of contact lenses for display.

The computing device 400 may have additional features or functionality, and additional interfaces to facilitate communications between the basic configuration 402 and any desired devices and interfaces. For example, a bus/interface controller 430 is used to facilitate communications between the basic configuration 402 and data storage devices 432 via a storage interface bus 434. The data storage devices 432 may be one or more removable storage devices 436, one or more non-removable storage devices 438, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives, among others. Example computer storage media includes volatile and non-volatile, removable and non-removable media implemented in any method or technology for storage of information, such as computer-readable instructions, data structures, program modules, or other data.

In some embodiments, an interface bus 440 facilitates communication from various interface devices (e.g., one or more output devices 442, one or more peripheral interfaces 444, and one or more communication devices 466) to the basic configuration 402 via the bus/interface controller 430. Some of the one or more output devices 442 include a graphics processing unit 448 and an audio processing unit 450, which is configured to communicate to various external devices such as a display or speakers via one or more A/V ports 452. The one or more peripheral interfaces 444 includes a serial interface controller 454 or a parallel interface controller 456, which are configured to communicate with external devices, such as input devices (e.g., keyboard, mouse, pen, voice input device, touch input device, etc.) or other peripheral devices (e.g., printer, scanner, etc.) via one or more I/O ports 458. An example of the one or more communication devices 466 include a network controller 460, which are arranged to facilitate communications with one or more other computing devices 462 over a network communication link via one or more communication ports 464. The one or more other computing devices 462 include servers, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media include wired media, such as a wired network or direct-wired connection, and wireless media, such as acoustic, radio frequency (RF), microwave, infrared (IR), and other wireless media. The term “computer-readable media,” as used herein, includes both storage media and communication media.

The system memory 406, the removable storage devices 436, and the non-removable storage devices 438 are examples of the computer-readable storage media. The computer-readable storage media is a tangible device that can retain and store instructions (e.g., program code) for use by an instruction execution device (e.g., the computing device 400). Any such, computer storage media is part of the computing device 400.

Aspects of the present invention are described herein regarding flowchart illustrations (e.g., FIG. 3) and/or block diagrams (e.g., FIG. 1, FIG. 2, and FIG. 4) of methods, apparatus (systems), and computer program products according to embodiments of the invention. It will be understood that each block of the flowchart illustrations and/or block diagrams, and combinations of blocks in the flowchart illustrations and/or block diagrams, can be implemented by the computer-readable instructions (e.g., the program code).

The computer-readable instructions are provided to the processor 404 of a general purpose computer, special purpose computer, or other programmable data processing apparatus (e.g., the computing device 400) to produce a machine, such that the instructions, which execute via the processor 404 of the computer or other programmable data processing apparatus, create means for implementing the functions/acts specified in the flowchart and/or block diagram block or blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable instructions (e.g., the program code) are also loaded onto a computer (e.g. the computing device 400), another programmable data processing apparatus, or another device to cause a series of operational steps to be performed on the computer, the other programmable apparatus, or the other device to produce a computer implemented process, such that the instructions which execute on the computer, the other programmable apparatus, or the other device implement the functions/acts specified in the flowchart and/or block diagram block or blocks.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computing device 400 or the computing device 102 (of FIG. 1) may be implemented as a part of a general purpose or specialized server, mainframe, or similar computer that includes any of the above functions. The computing device 400 or the computing device 102 (of FIG. 1) may also be implemented as a personal computer including both laptop computer and non-laptop computer configurations.

Another embodiment of the invention provides a method that performs the process steps on a subscription, advertising and/or fee basis. That is, a service provider, such as a Solution Integrator, can offer to create, maintain, and/or support, etc. a process of collaborative conferencing between participants wearing smart contact lenses. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

What is claimed is:

1. A computer program product, comprising one or more computer-readable hardware storage devices having computer-readable program code stored therein, the computer-readable program code containing instructions executable by one or more processors of a computer system to implement a method for collaborative conferencing between participants wearing smart contact lenses, the method comprising:
receiving, by the one or more processors from a first device paired with a first set of smart contact lenses worn by a first participant of the participants, a first video content of a presentation;
receiving, by the one or more processors from a second device paired with a second set of smart contact lenses worn by a second participant of the participants, a second video content of the presentation;
analyzing, by the one or more processors, the first video content to identify a first set of parameters;
analyzing, by the one or more processors, the second video content to identify a second set of parameters; and
in response to a determination that the first and the second set of parameters fail to exceed a threshold,
combining, by the one or more processors, the first video content and the second video content to create a third video content; and
transmitting, by the one or more processors, the third video content to the first and the second set of contact lenses for display.

2. The computer program product of claim 1, wherein the first and the second set of parameters are selected from the group consisting of: a number of the participants, a context associated with the presentation, a location of each of the participants, and a viewing angle associated with a view of each of the participants.

3. The computer program product of claim 1, the method further comprising:
receiving, by the one or more processors from the first device, first audio content associated with the presentation;
receiving, by the one or more processors from the second device, second audio content associated with the presentation;
combining, by the one or more processors, the first and second audio content into third audio content; and
transmitting, by the one or more processors, the third audio content to the first and the second device.

4. The computer program product of claim 1, wherein the first video content is captured within a line of sight of the first participant, and wherein the second video content is captured within a line of sight of the second participant.

5. The computer program product of claim 1, wherein the participants are co-located.

6. The computer program product of claim 1, the method further comprising:
transmitting a request to a third user associated with the computer program product to prompt the third user to confirm the first and the second set of parameters as failing to exceed the threshold.

7. The computer program product of claim 6, wherein the third user is a speaker of the presentation.

8. The computer program product of claim 1, wherein the presentation is associated with a collaborative video conference.

9. A computer system, comprising one or more processors, one or more memories, and one or more computer-readable hardware storage devices, the one or more computer-readable hardware storage devices containing program code executable by the one or more processors via the one or more memories to implement a method for collaborative conferencing between participants wearing smart contact lenses, the method comprising:
receiving, by the one or more processors from a first device paired with a first set of smart contact lenses worn by a first participant of the participants, a first video content of a presentation;
receiving, by the one or more processors from a second device paired with a second set of smart contact lenses worn by a second participant of the participants, a second video content of the presentation;
analyzing, by the one or more processors, the first video content to identify a first set of parameters;
analyzing, by the one or more processors, the second video content to identify a second set of parameters; and
in response to a determination that the first and the second set of parameters fail to exceed a threshold,
combining, by the one or more processors, the first video content and the second video content to create a third video content; and
transmitting, by the one or more processors, the third video content to the first and the second set of contact lenses for display.

10. The computer system of claim 9, wherein each of the first and the second set of smart contact lenses comprise:
a lens component configured to be worn on an eyeball of the first or the second participant.

11. The computer system of claim 10, wherein the lens component comprises:
a sensor component configured to capture the first or the second video content of the presentation; and
a display component configured to display the third video content.

12. The computer system of claim 9, wherein each of the first and the second set of smart contact lenses comprise:
a storage component configured to store the first and the second video content; and
a transmission component configured to transmit the first or the second video content to a conferencing application of the first or the second device.

13. A method comprising:
receiving, by one or more processors from a first device paired with a first set of smart contact lenses worn by a first participant of the participants, a first video content of a presentation;
receiving, by the one or more processors from a second device paired with a second set of smart contact lenses worn by a second participant of the participants, a second video content of the presentation;
analyzing, by the one or more processors, the first video content to identify a first set of parameters;
analyzing, by the one or more processors, the second video content to identify a second set of parameters; and
in response to a determination that the first and the second set of parameters fail to exceed a threshold,
combining, by the one or more processors, the first video content and the second video content to create a third video content; and
transmitting, by the one or more processors, the third video content to the first and the second set of contact lenses for display.

14. The method of claim 13, further comprising:
executing, by the one or more processors, a natural language processing (NLP) algorithm on the first video content to identify a discussion topic associated with the first video content of the presentation, wherein the discussion topic is a parameter of the first set of parameters; and
executing, by the one or more processors, the NLP algorithm on the second video content to identify another discussion topic associated with the second video content of the presentation, wherein the other discussion topic is a parameter of the second set of parameters.

15. The method of claim 13, wherein the first and the second set of parameters include a viewing angle associated with a view of the presentation of each of the participants.

16. The method of claim 15, further comprising:
detecting a seating arrangement of each participant based on the viewing angle.

17. The method of claim 13, wherein the first device is paired via Bluetooth with the first set of smart contact lenses, and wherein the second device is paired via Bluetooth with the second set of smart contact lenses.

18. The method of claim 13, further comprising:
transmitting a request to a third user associated with the computer program product to prompt the third user to confirm the first and the second set of parameters as failing to exceed the threshold, wherein the third user is a speaker of the presentation.

19. The method of claim 13, wherein the first and the second set of parameters are selected from the group consisting of: a number of the participants, a context associated with the presentation, a location of each of the participants, and a viewing angle associated with a view of each of the participants.

20. The method of claim 13, further comprising:
if the first set of parameters exceed the threshold, transmitting, by the one or more processors, the first video content to the first and the second set of contact lenses for display; else
if the second set of parameters exceed the threshold, transmitting, by the one or more processors, the second video content to the first and the second set of contact lenses for display.
